(19) United States
(12) Patent Application Publication
(10) Pub. No.: US 2025/0378765 A1
(43) Pub. Date: Dec. 11, 2025

(54) SYSTEM AND METHODS FOR IMPROVING USER ENGAGEMENT AND ASSESSMENT VALIDITY BY DYNAMICALLY GENERATING TEST ITEMS

(71) Applicant: University of Kansas, Lawrence, KS (US)

(72) Inventors: Neal M. Kingston, Lawrence, KS (US); Susan E. Embretson, Lawrence, KS (US)

(73) Assignee: University of Kansas, Lawrence, KS (US)

(21) Appl. No.: 19/228,107

(22) Filed: Jun. 4, 2025

Related U.S. Application Data
(60) Provisional application No. 63/657,483, filed on Jun. 7, 2024.

(51) Int. Cl. G09B 7/00; G06F 16/335; H04L 67/306

(52) U.S. Cl. CPC G09B 7/00; G06F 16/335; H04L 67/306

(57) ABSTRACT

The present disclosure relates to systems, methods, and computer-readable media for a dynamic content generation system that efficiently, accurately, and flexibly generates dynamic sets of content items based on different sets of identified information. For example, the dynamic content generation system identifies a template of content items along with different sets of user information. Additionally, for each set of user information, the dynamic content generation system generates a personalized and unique set of dynamic content items by correlating pieces of user information from the given user with parameterized variables from the template of content items.

### CROSS-REFERENCE TO RELATED APPLICATIONS

This application claims priority to and the benefit of U.S. Provisional Patent Application No. 63/657,483, filed Jun. 7, 2024, the entirety of which is incorporated by reference in its entirety.

### BACKGROUND

In recent years, there have been notable advancements in computerized testing and evaluation systems, particularly in the field of academic testing and evaluation. Many educational institutions have adopted computer software to administer assignments, lessons, projects, and exams to students through various modes. However, despite these advances, conventional computer systems that present instructional or assessment materials to students are limited in their capabilities.

One of the most pressing issues is the inflexibility of conventional computer systems, which limits the types of content that can be presented to students and can create bias among students. This rigidity ultimately can lead to inaccurate and invalid results. Additionally, conventional computer systems waste processing power and memory resources by generating, administering, evaluating, and storing these inaccurate results.

These and other problems exist in conventional computer systems with regard to providing and managing content items among users, such as students.

### BRIEF DESCRIPTION OF THE DRAWINGS

The detailed description provides one or more embodiments with additional specificity and detail through the use of the accompanying drawings, as briefly described below.

FIG. 1 illustrates an example overview of implementing a dynamic content generation system to generate sets of dynamic items in accordance with one or more implementations.

FIG. 2 illustrates an example system environment where a dynamic content generation system is implemented in accordance with one or more implementations.

FIG. 3 illustrates an example process for generating a template for dynamic items in accordance with one or more implementations.

FIG. 4 illustrates an example process for identifying user information in accordance with one or more implementations.

FIG. 5 illustrates an example process for generating sets of dynamic items in accordance with one or more implementations.

FIG. 6 illustrates examples of user interfaces for providing different sets of dynamic items to different users in accordance with one or more implementations.

FIG. 7 illustrates an example series of acts for generating sets of dynamic items from a common template in accordance with one or more implementations.

FIG. 8 illustrates computing components that may be included within a computer system.

### DETAILED DESCRIPTION

The present disclosure describes a dynamic content generation system that efficiently, accurately, and flexibly generates dynamic sets of items with variabilized content based on different sets of identified information. For example, the dynamic content generation system uses templates for items along with different sets of user information to variablize specific content of the items. Additionally, for each set of user information, the dynamic content generation system generates a unique set of dynamic items by incorporating pieces of user information from the given user into the variabilized aspect of content in the item templates.

As a non-limiting example, suppose a class of 20 students has been given an assignment with ten questions. Rather than providing the same assignment to each of the students, the dynamic content generation system identifies a set of user information for each student and dynamically generates 20 different versions of the assignment that are tailored to each student. In this manner, each student is given an equivalent assignment that is contextually customized to their own positive associations.

As discussed in further detail below, the present disclosure includes several practical applications with features and functionalities described herein that provide benefits and/or solve the problems mentioned above. For example, in one or more implementations, the dynamic content generation system provides improved flexibility over conventional computer systems by generating sets of items that are dynamically customized to a user's affinities. By providing dynamic sets of items to users (e.g., items with variabilized content that is dynamically determined based on the user), the dynamic content generation system provides users with more accurate content (e.g., less unclear and confusing content) and results in more engaged user interactions (e.g., users provide more valid answers when engaged with dynamic content).

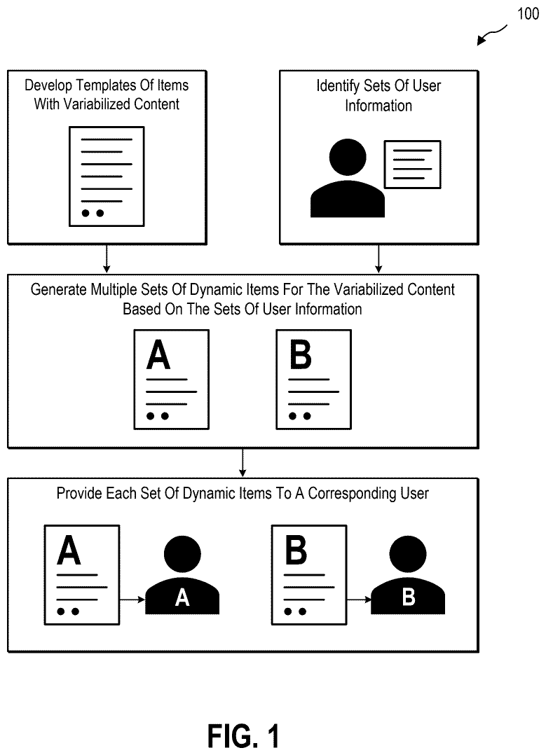

Additional details regarding the dynamic content generation system are provided with reference to the figures portraying example implementations. For example, FIG. 1 illustrates an example overview of implementing a dynamic content generation system to generate sets of dynamic items in accordance with one or more implementations. As shown, FIG. 1 includes a series of acts 100 that the dynamic content generation system may perform.

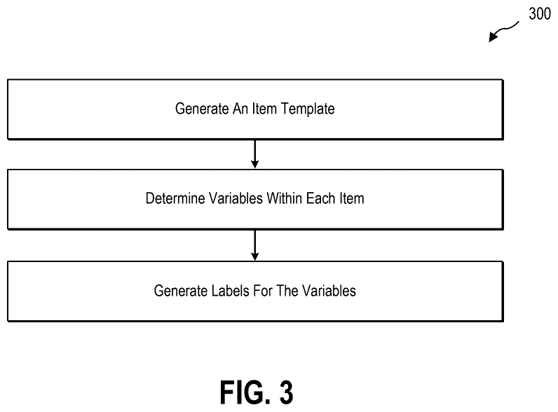

As illustrated, the series of acts 100 includes an act of developing templates of items with variabilized content. For example, the dynamic content generation system generates a set of items, such as questions. In another example, the dynamic content generation system receives a set of items for another system or user, such as an administrator. In various instances, one or more of the items in the template includes one or more variables, which are often parameterized variables. Additional details regarding generating item templates are provided below in connection with FIG. 3.

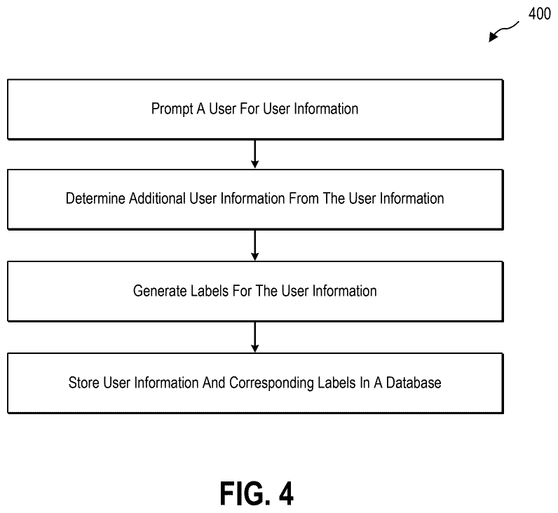

The series of acts 100 also includes an act of identifying sets of user information. For example, the dynamic content generation system accesses, requests, queries, looks up, or otherwise identifies different sets of user information corresponding to different user identifiers of different users. In some implementations, the sets of user information are securely stored in a database that stores user profile information. In this document, user information includes any information provided by a user or directly identified based on user information provided by the user. Additional details regarding identifying user information are provided below in connection with FIG. 4.

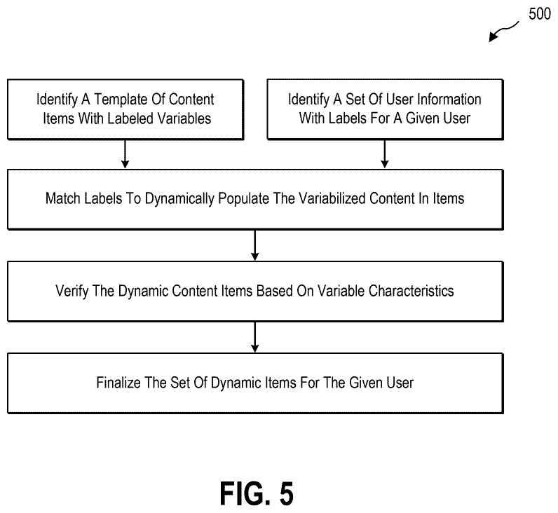

As shown, the series of acts 100 includes an act of generating multiple sets of dynamic items for the variabilized content based on the sets of user information. For example, the dynamic content generation system generates different unique sets of dynamic items based on different sets of user information. In various instances, the dynamic content generation system generates a dynamic set of items by, among other things, replacing parameterized variables in items from the template with correlation pieces of user information. Additional details regarding generating dynamic items based on user information are provided below in connection with FIG. 5.

Additionally, the series of acts 100 includes an act of providing each set of dynamic items to a corresponding user. For example, the dynamic content generation system provides the dynamic item set generated based on each set of user information to the corresponding user. In this way, the dynamic content generation system provides customized items to two users while still maintaining parity across both users.

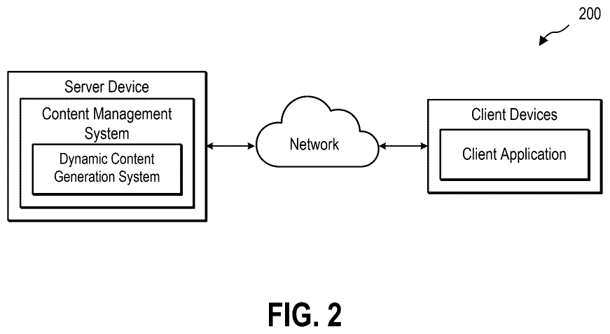

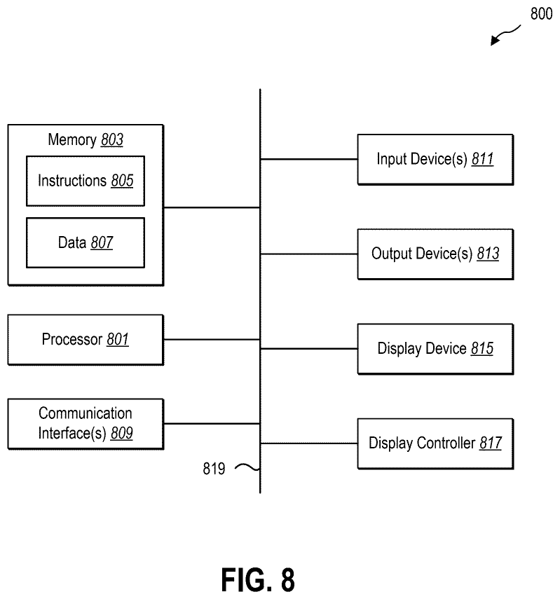

FIG. 2 illustrates a schematic diagram of an environment 200 of a computing system (e.g., a digital medium system environment) for implementing the dynamic content generation system. As shown, the environment 200 includes a server device and client devices that communicate via a network. In some instances, the environment 200 includes additional components, such as one or more local or remote databases (i.e., data stores) for storing items, templates, and/or user information. Additional details regarding these computing devices and networks are provided below in connection with FIG. 8.

In various implementations, the server device includes one or more computing devices, such as multiple server devices. In some implementations, the functions of the server device are performed by a client device, such as an administrator client device. As shown, the server device includes a content management system and the dynamic content generation system. In some implementations, the server device also includes data stores and/or other components, such as a data privacy manager.

In various implementations, the content management system manages content, including items. Content can include content from templates as well as dynamically generated items. The content management system can facilitate receiving, storing, accessing, modifying, removing, and/or otherwise managing digital content.

As shown, the content management system includes the dynamic content generation system. In some implementations, the dynamic content generation system is located outside of the content management system. In various implementations, the dynamic content generation system generates sets of dynamic items for users as further described below.

In various implementations, the client devices are associated with user identifiers, representing users who interact with the dynamic content generation system to request sets of dynamic items or users receiving a set of dynamic items. As shown, the client device includes a client application that provides functions, such as accessing different parts of the dynamic content generation system.

With the foundation of the dynamic content generation system established, additional details regarding various functions of the dynamic content generation system will now be described. As mentioned earlier, FIG. 3 provides additional details for generating item templates. In particular, FIG. 3 illustrates an example process for generating a template for items in accordance with one or more implementations. As shown, FIG. 3 includes a series of acts 300 performed by the dynamic content generation system.

To illustrate, the series of acts 300 includes an act of generating an item template (e.g., a template of items). For example, in various implementations, the dynamic content generation system creates a template of items for a particular topic or subject. For instance, the dynamic content generation system generates questions for a test, lesson, homework, or assignment. In some implementations, the dynamic content generation system selects a set of questions from a larger pool of items (e.g., questions) based on specific criteria, such as beginning algebra questions.

In some cases, a software system provides one or more items. For instance, a testing software company provides a set of word problems, which the dynamic content generation system converts into an item template, as described below. In various implementations, the dynamic content generation system receives one or more items for a template from a user, such as an administrator user or an item creator.

As shown, the series of acts 300 includes an act of determining variables within each item. For example, the dynamic content generation system identifies parameterized variables (e.g., variable-based items or countable items) in one or more of the items in the item template. As another example, the dynamic content generation system analyzes an item to convert one or more portions (e.g., words) of the item into one or more parameterized variables.

In this document, a parameterized variable (or simply variable) includes an item that is characterized by one or more attributes, such as parts-of-speech, a range of values, object type, count, environment, and/or context, among other attributes. For example, an item (e.g., a word or phrase) of an item may be a first type of parameterized variable that indicates it is a pronoun. As another example, an item may be a second type of parameterized variable that indicates it is a location. As still another example, an item may be a third type of parameterized variable that indicates it is an object having a count between 1-3 instances, found in a grocery store, able to fit in a shopping bag, and costs between $2-$5. Indeed, a parameterized variable may include any number of characteristics, attributes, and/or criteria specifying an item (e.g., word or phrase) within an item (e.g., a sentence).

As mentioned above, in various implementations, a template of items includes items having parameterized variables. For example, the items have a fillable field for each item having a parameterized variable. The item may be blank, have a default value (e.g., a default word), or have a randomized word. As mentioned above, the item may have metadata that includes all the criteria for a word or phrase that correlates with it and/or the fillable field.

In some implementations, the dynamic content generation system generates one or more parameterized variables for an item. To illustrate, the series of acts 300 shows an act of determining variables within each item. For example, the dynamic content generation system identifies and/or generates parameterized variables for the items in the template of items.

In some implementations, the dynamic content generation system generates and/or adds additional parameterized variables to an item in the template of items. For example, when given a default sentence without a parameterized variable, the dynamic content generation system utilizes a natural-language processing (NLP) model and/or another type of language processing machine-learning model (e.g., an LSTM) to analyze the sentence and determine one or more items (e.g., words or phrases) in the sentence to be parameterized.

In various implementations, the dynamic content generation system determines labels or tags for the parameterized variable. To illustrate, the series of acts 300 includes generating labels for the variables. For example, the dynamic content generation system identifies, accesses, determines, and/or generates labels for a parameterized variable that includes corresponding criteria. In some implementations, the dynamic content generation system determines labels following a set of rules and/or heuristics. In some implementations, the labels are received from a user (e.g., an administrator).

In various implementations, the dynamic content generation system utilizes the NLP model and/or the other type of language processing machine-learning model described above to determine labels. For example, in addition to determining which words in a sentence to make into parameterized variables, the model also determines corresponding labels (e.g., criteria) for the items.

As a simplistic example of determining labels for an item, suppose the dynamic content generation system analyzes the sentence “She ate 2 red apples.” In this example, the dynamic content generation system could convert this item into “<person> ate 3<food object & reasonable to eat up to 3 instances>,” where “<item>” represents an item with a label having one or more given criteria. Alternatively, the dynamic content generation system could convert the item into “<person> <action>3<noun/adjective+noun & object>,” meaning the last item could have a label indicating a word or phrase that is a noun or a noun with an adjective and where the word or phrase is also an object.

In some implementations, the dynamic content generation system uses a look-up system or submit queries to determine label information for an item. For example, the dynamic content generation system asks questions on a search engine or to a machine-learning model regarding an item in an item. For instance, the dynamic content generation system asks for the definition of an item, in what context it is commonly used, what types of users use the item, and the average cost of the item. The dynamic content generation system can determine other characteristics and attributes such as the size, color, quality, and/or weight of the item. In some implementations, the dynamic content generation system maintains an item database that includes some or all of this information.

As mentioned above, FIG. 4 provides additional details regarding the identification of user information and sets of user information. In particular, FIG. 4 illustrates an example process for identifying user information in accordance with one or more implementations. As shown, FIG. 4 includes a series of acts 400 performed by the dynamic content generation system.

As depicted, the series of acts 400 includes an act of prompting a user for user information. For example, the dynamic content generation system prompts a user to provide an initial set of user information. In one or more implementations, the dynamic content generation system prompts a user for user information just before generating and providing the user with a dynamic set of items. In alternative implementations, the dynamic content generation system prompts the user for user information at an earlier time. For example, a student provides user information at the beginning of a school year for the dynamic content generation system to use throughout the school year.

User information often includes familiar, but not sensitive, information. For example, while user information does not include passwords or account numbers, it may include personal facts associated with the user. Examples of user information include names and relationships, such as the user's given name, nicknames, friends, family members, classmates, or teachers; locations such as where the user generally lives, the school they attend, where they work or like to hang out, or where they want to vacation; activities such as home life, hobbies, work life, commuting, or leisure activities; among other types of user information. User information can also include user preferences, such as topics related to food, television, movies, music, art, books, sports, etc. Indeed, the dynamic content generation system may ask just a few select questions or a large range of questions to better determine a user profile that contextualizes the user and their preferences.

In many implementations, the dynamic content generation system provides users with control over the information they share. For example, the dynamic content generation system allows users to skip or ignore requests for user information. Various implementations allow a user to add, edit, remove, or modify their user information. In some instances, the dynamic content generation system allows a user to determine how long the dynamic content generation system maintains the user information. Further, the dynamic content generation system can provide instructions for how the dynamic content generation system can use the provided information to gather additional contextual data for a user, as discussed below.

In one or more implementations, the dynamic content generation system provides users with a list of answers to select from in response to a prompt. For example, a user may select one or more items from a list and/or manually provide their own items.

In some implementations, a user may not wish to provide user information. For example, the dynamic content generation system indicates that a user may provide fictitious information in place of the user. Even in this case, the information provided by the user will be more meaningful, more engaging, and less distracting to the user than the default items.

In various implementations, the dynamic content generation system verifies that input information is appropriate for the academic setting (e.g., disallows negative phrases, curse words, offensive terms, and other inappropriate language).

As shown, the series of acts 400 includes an act of determining additional user information from the user information. In various implementations, the dynamic content generation system uses the information provided by the user to determine a clearer context and/or gather additional contextual data for a user. For example, given the general location of where the user resides, the dynamic content generation system can determine the names of local attractions such as parks, shops, city buildings, restaurants, geographical features, and neighboring cities, among others. As another example, given a user's favorite movie, the dynamic content generation system can identify the names of the main characters and important plot points.

In various implementations, the dynamic content generation system uses one or more pieces of provided user information in a forward search engine query to determine additional user information from the search results. In some implementations, the dynamic content generation system provides pieces of known user information to a database or lookup table to identify the additional user information.

In some implementations, the user provides usernames or other details that allow the dynamic content generation system to further identify public information about the user. For example, the user information includes a social media username, where the user publicly posts things of interest. In certain implementations, a user provides a user profile generated by another service to the dynamic content generation system to determine additional user information about the user.

As a note, the dynamic content generation system determines a unique profile for each user. Additionally, the dynamic content generation system does not make assumptions about a user based on common stereotypes or categorization. For example, if the user indicates a preference for a given comedy TV show, the dynamic content generation system does not assume the user likes a similar comedy TV show. Similarly, the dynamic content generation system does not assume that because the user has a name predominantly found in France (e.g., Étienne) that the user frequently eats baguettes. Rather, the dynamic content generation system builds a personalized context for a user (i.e., user identifier) based on user-provided information and facts that can be determined from the user-provided information (e.g., the system determines the name of the mascot for a local sports team for which the user has indicated a preference).

As also shown, the series of acts 400 includes an act of generating labels for the user information. For example, in various implementations, the dynamic content generation system processes and analyzes the user information to determine labels or tags for each item.

In some implementations, the dynamic content generation system uses a similar approach as it did to determine labels for items in the item template. For example, the dynamic content generation system uses rules, heuristics, an NLP model, and/or another type of language processing machine-learning model to determine labels based on the characteristics and attributes of the pieces of user information.

In some implementations, the dynamic content generation system uses a look-up system or submits queries to determine label information for a piece of user information. For example, the dynamic content generation system asks questions regarding an item provided by a user. For instance, the dynamic content generation system queries the average cost, size, color, quality, and/or weight of an item a user likes.

In various implementations, a prompt for a piece of user information may be associated with a label type. For example, a prompt for a name is associated with the label “Name” and a prompt for a general location where a user lives is associated with the label “Location.” Similarly, a prompt for small-sized treats that a user likes to eat is associated with various labels, such as a “Food” label, a “Size” label, a “Price Range” label, and a “Quality” label. In this way, when prompting a user for pieces of user information, the dynamic content generation system may have one or more labels associated with a given answer due to the nature of the prompt.

Additionally, the series of acts 400 includes an act of storing the user information and labels in a database. For example, the dynamic content generation system stores (e.g., either temporarily or in long-term storage) the set of user information for a user in a database or another type of data store. In various implementations, the dynamic content generation system uses layers of security, privacy protections, and safeguards to protect the integrity of the user's information, even if it does not include sensitive data.

As mentioned above, in some implementations, the dynamic content generation system stores the user information for a period of time, such as a few days, weeks, months, or years. In alternative implementations, the dynamic content generation system keeps user information just long enough to generate a set of dynamic items for the user. For example, the dynamic content generation system generates dynamic items upon identifying the user information without further retaining the user information.

In general, the dynamic content generation system does not maintain user information for long periods of time. Rather, the dynamic content generation system re-prompts a user for new and/or updated information, if needed. For example, for a high-school student, the dynamic content generation system prompts the user to confirm or enter new information each semester. Then, upon the student leaving the school, the dynamic content generation system removes the user information for the student. Notably, the dynamic content generation system maintains user information for the purpose of improving positive user engagement as well as academic validity and not for any other purpose.

As mentioned above, FIG. 5 provides additional details regarding generating dynamic items based on user information. In particular, FIG. 5 illustrates an example process for generating sets of dynamic items in accordance with one or more implementations. As illustrated, FIG. 5 includes a series of acts 500 performed by the dynamic content generation system.

As shown in FIG. 5, the series of acts includes an act of identifying a template of items with labeled variables. As provided above, the dynamic content generation system can generate or otherwise obtain a template of items. For example, a teacher administering a test or assignment to their students creates a new template (as discussed above) or loads a previously generated template. In another example, the dynamic content generation system identifies a set of test questions and converts them into an item template with label variables (i.e., parameterized variables) as discussed above.

Additionally, FIG. 5 shows that the series of acts 500 includes an act of identifying a set of user information with labels for a given user. For example, the dynamic content generation system receives the user identifier for a given user and uses the user identifier to identify user information stored for the user, as discussed above. As also discussed above, pieces of user information may have labels that indicate corresponding attributes and characteristics.

As shown, the series of acts 500 includes an act of matching labels to dynamically populate the variabilized content in items. For example, the dynamic content generation system generates a set of dynamic items for the template of items by populating or rewriting the parameterized variables in the items with correlated pieces of user information for the given user.

In various instances, the dynamic content generation system matches labels between the item template and the pieces of user information to determine dynamic items. To illustrate, the dynamic content generation system populates a pronoun variable with the user's name and a noun variable with an item for which the user has expressed a preference.

As another illustration, an item in the template includes variables for three names and a variable for a shared item in a higher price range. Here, the dynamic content generation system identifies three related names provided by the user (e.g., friends, family members, classmates). Additionally, the dynamic content generation system determines an item of interest to the user that matches the given price range. If the dynamic content generation system identifies multiple qualifying items from the user information of the given user, the dynamic content generation system may determine which item has the strongest correlation to the user and/or the select group of names. In some instances, the dynamic content generation system uses a default item if none matches (or meets a minimum matching threshold) the variable in the item.

In some implementations, the dynamic content generation system utilizes a correlation machine-learning model to determine correlation strengths between a variable in an item and a piece of user information. The correlation model may account for various types of labels for the parameterized variable and map inputs into an n-dimensional feature vector space. The dynamic content generation system then selects the piece of user information that maps closest in the feature vector space to the mapping of the variable from the template item (and that meets a minimum threshold distance). In various implementations, the correlation machine learning model incorporates user-item, user-user, and/or item-item correlations.

As shown, the series of acts 500 includes an act of verifying the dynamic items based on variable characteristics. For example, the dynamic content generation system validates the dynamic items for realism and authenticity. In general, when populating a variable of an item from the template, the dynamic content generation system adheres to the parameters indicated by the labels of the variables. However, in some instances, a variable may lack the relevant parameters or the parameters may be incorrect. Accordingly, the dynamic content generation system verifies the practicality of the dynamic items.

To illustrate, the dynamic content generation system determines if a dynamic item is plausible. For example, if the item indicates that a user is buying 25 gallons of milk or is paying $1,000 for 12 apples, the dynamic content generation system may determine that one or more variables of the dynamic item need to be modified and re-validated. In some implementations, the dynamic content generation system uses a search engine or an NLP machine-learning model to determine if a dynamic item is valid. Similarly, in some instances, the dynamic content generation system tests to ensure that the rewritten or populated variables properly correlate to each other.

In various implementations, the dynamic content generation system performs various types of validation tests. For example, in some implementations, the dynamic content generation system validates that if a dynamic item includes multiple rewritten or populated items, the items are not too similar or conflicting with each other. Furthermore, in various implementations, the dynamic content generation system performs a sensitivity test to ensure that dynamic items do not include inappropriate content that was previously missed.

As shown, the series of acts 500 includes an act of finalizing the dynamic items for the given user. For example, the dynamic content generation system indicates that the set of dynamic items generated for the given user from the template of items has passed the one or more validation checks.

In some instances, the dynamic content generation system stores the finalized set of dynamic items for the given user. In various implementations, the dynamic content generation system provides the set of dynamic items to the user (e.g., to a client device associated with the user) so that the user can engage with it.

Moreover, the dynamic content generation system can repeat the series of acts 500 for multiple given users. For example, the dynamic content generation system generates multiple sets of dynamic items from the same template of items. For instance, for a class of 35 students, the dynamic content generation system generates 35 different versions of the same assignment from a template of assignment questions, where each assignment version is equally challenging but personally contextualized to each student. As a result, more students engage with the assignment customized for them, which improves the validity of the results of the assignment.

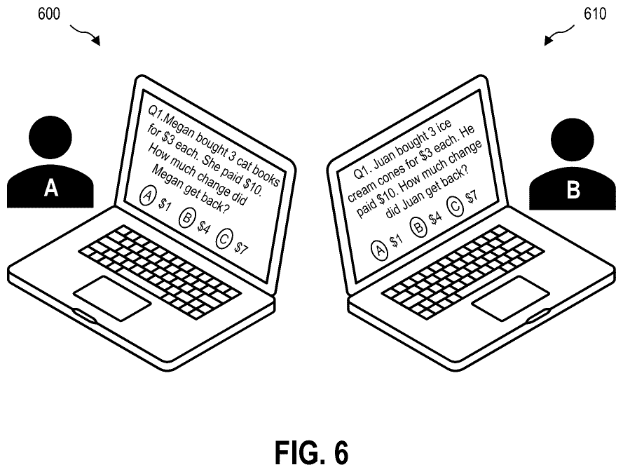

FIG. 6 illustrates examples of interactive interfaces for providing different sets of dynamic items to different users in accordance with one or more implementations. FIG. 6 provides an example of one of the many scenarios in which the dynamic content generation system may operate.

As shown, FIG. 6 includes a first client device associated with a first user (User A) that displays a first dynamic item 600. FIG. 6 also includes a second client device associated with a second user (User B) that displays a second dynamic item 610. As shown, the first dynamic item and the second dynamic item 610 are similar (e.g., they ask the same question), but they are personalized to their respective users. In this manner, User A is more likely to engage with the first dynamic item and User B is more likely to engage with the second dynamic item.

In some implementations, the dynamic content generation system works in real-time while a user is engaging with a set of dynamic items. For example, the dynamic content generation system provides one or more options for a user to provide feedback on a dynamic item or a rewritten or populated variable within the dynamic item. Here, the dynamic content generation system may change the variable in the dynamic item and other dynamic items that include the same populated variable. Likewise, as the user provides feedback, the dynamic content generation system uses the feedback in generating further dynamic items for the user. Also, in some instances, the dynamic content generation system limits the number of times a user can change a populated variable to minimize distractions when engaging with the dynamic item.

As noted above, the dynamic item may be implemented with an existing assignment, project, evaluation, or testing system. In some cases, these systems may need to modify one or more aspects, such as adding a user profile database, to accommodate the dynamic content generation system. For example, testing software that integrates the dynamic content generation system may add new infrastructure to generate personalized databases that use sets of user information as well as add instructions to generate and populate templates of items, as discussed above.

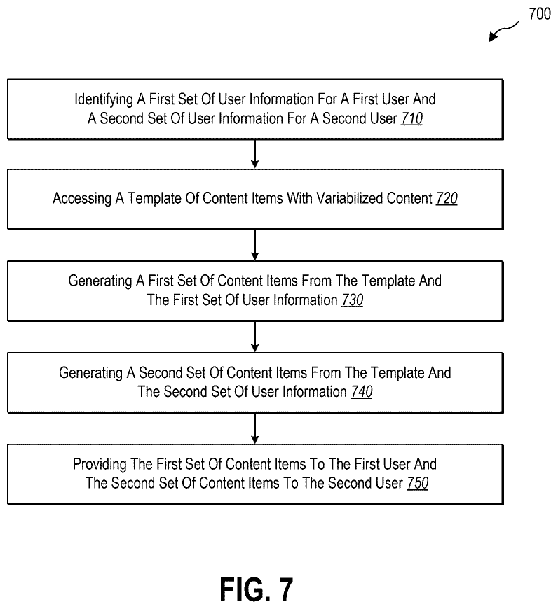

Turning now to FIG. 7, this figure illustrates an example flowchart that includes a series of acts 700 for generating sets of dynamic items from a common template in accordance with one or more implementations. While FIG. 7 illustrates acts according to one or more embodiments, alternative embodiments may omit, add to, reorder, and/or modify any of the acts shown. The acts of FIG. 7 can be performed as part of a method. Alternatively, a non-transitory computer-readable medium can include instructions that, when executed by one or more processors, cause a computing device to perform the acts of FIG. 7. In still further embodiments, a system can perform the acts of FIG. 7.

As shown in FIG. 7, the series of acts 700 includes an act 710 of identifying a first set of user information for a first user and a second set of user information for a second user. For instance, the act 710 can involve identifying a first set of user information corresponding to a first user; and identifying a second set of user information corresponding to a second user, where the second set of user information differs from the first set of user information.

As further shown, the series of acts 700 includes an act 720 of accessing a template of items with variabilized content (e.g., parameterized variables). For instance, the act 720 can involve accessing a template of items, wherein each of the items includes one or more parameterized variables.

As shown, the series of acts 700 includes an act 730 of generating a first set of content items from the template and the first set of user information. For instance, the act 730 can involve generating a first set of dynamic content items by incorporating the first set of user information into the template of content items.

As further shown, the series of acts 700 includes an act 740 of generating a second set of content items from the template and the second set of user information. For instance, the act 740 can involve generating a second set of dynamic content items by incorporating the second set of user information into the template of content items, where the second set of dynamic content items differs from the first set of dynamic content items.

As shown, the series of acts 700 includes an act 750 of providing the first set of content items to the first user and the second set of content items to the second user. For instance, the act 750 can involve providing the first set of dynamic content items to a first client device associated with the first user and providing the second set of dynamic content items to a second client device associated with the second user.

In some implementations, the techniques described herein relate to a computer-implemented method including: receiving, in connection with administering a test, a first set of user information from a first client device associated with a first user; receiving, in connection with administering the test, a second set of user information from a second client device associated with a second user; generating a first set of personalized test questions based on the first set of user information into a template of parameterized variable test questions; generating a second set of personalized test questions based on the second set of user information into the template of parameterized variable test questions, wherein the first set of personalized test questions differs from the second set of personalized test questions; providing the first set of personalized test questions to the first client device; and providing the second set of personalized test questions to the second client device.

In some implementations, the techniques described herein relate to a computer-implemented method, further including: determine additional contextual information by querying the first set of user information; and generating the first set of personalized test questions by incorporating the first set of user information and the additional contextual information into the template of parameterized variable test questions.

In some aspects, the techniques described herein relate to a computer-implemented method including: identifying a first set of user information corresponding to a first user; identifying a second set of user information corresponding to a second user, wherein the first set of user information differs from the second set of user information; accessing a template of content items, wherein each of the content items includes one or more parameterized variables; generating a first set of content items by incorporating the first set of user information into the template of content items; generating a second set of content items by incorporating the second set of user information into the template of content items, wherein the first set of content items differs from the second set of content items; providing the first set of content items to a first client device associated with the first user; and providing the second set of content items to a second client device associated with the second user.

In some implementations, the techniques described herein relate to a computer-implemented method, wherein: the template of content items corresponds to a set of test questions; generating the first set of content items includes generating a first set of test questions rewritten to incorporate personalized information of the first user determined from the first set of user information; and providing the first set of content items to the first client device includes providing the first set of test questions personalized for the first user to the first user.

In some implementations, the techniques described herein relate to a computer-implemented method, wherein identifying the first set of user information corresponding to the first user includes receiving user input from the first user via the first client device.

In some implementations, the techniques described herein relate to a computer-implemented method, wherein identifying the first set of user information corresponding to the first user includes receiving user input from the first user via a third client device that is different from the first client device.

In some implementations, the techniques described herein relate to a computer-implemented method, wherein identifying the first set of user information corresponding to the first user includes accessing the first set of user information from a user profile database that stores sets of user information.

In some implementations, the techniques described herein relate to a computer-implemented method, wherein the template of content items is stored in a database that is separate from the user profile database.

In some implementations, the techniques described herein relate to a computer-implemented method, wherein identifying the first set of user information corresponding to the first user includes: receiving an initial set of user inputs from the first user; and performing queries using the initial set of user inputs to determine the first set of user information.

In some implementations, the techniques described herein relate to a computer-implemented method, wherein: the initial set of user inputs includes a location; and determining the first set of user information includes identifying names, places, people, and features corresponding to the location.

In some implementations, the techniques described herein relate to a computer-implemented method, wherein identifying the first set of user information corresponding to the first user occurs around a same time and/or in connection with generating and providing the first set of content items to the first client device.

In some implementations, the techniques described herein relate to a computer-implemented method, wherein identifying the first set of user information corresponding to the first user occurs at a previous and separate time from generating and providing the first set of content items to the first client device.

In some aspects, the techniques described herein relate to a computer-implemented method, further including: accessing an additional template of additional content items, wherein each of the additional content items includes one or more parameterized variables; generating a third set of content items by incorporating the first set of user information into the additional template of additional content items; and providing the third set of content items to a third client device associated with the first user.

In some implementations, the techniques described herein relate to a computer-implemented method, wherein a parameterized variable for a content item in the template includes a parameter tag identifying a part of speech.

In some implementations, the techniques described herein relate to a computer-implemented method, wherein a parameterized variable for a content item in the template includes a parameter tag identifying an object type.

In some implementations, the techniques described herein relate to a computer-implemented method, wherein a parameterized variable for a content item in the template includes a parameter tag identifying a corresponding object value range.

In some implementations, the techniques described herein relate to a computer-implemented method, wherein a parameterized variable for a content item in the template is associated with a numerical value or fixed element with the content item.

In some implementations, the techniques described herein relate to a computer-implemented method, wherein the template is associated with a computerized test or examination.

In some implementations, the techniques described herein relate to a computer-implemented method, wherein the template is associated with a lesson or a homework assignment.

In some implementations, the techniques described herein relate to a system including: a processor; a computer memory that includes: a first set of user information associated with a first user and a second set of user information associated with a second user, the first set of user information differing from the second set of user information; and a template of content items, each of the content items including one or more parameterized variables; and instructions that, when executed by the processor, cause the system to carry out operations that include: generating a first set of content items by incorporating the first set of user information into the template of content items; generating a second set of content items by incorporating the second set of user information into the template of content items, wherein the first set of content items differs from the second set of content items; providing the first set of content items to a first client device associated with the first user; and providing the second set of content items to a second client device associated with the second user.

FIG. 8 illustrates certain components that may be included within a computer system 800. The computer system 800 may be used to implement the various computing devices, components, and systems described herein. As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU). Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the network function configuration system. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include, for example, instructions and data that, when executed by a processor, cause a general-purpose computer, special-purpose computer, or special-purpose processing device to perform a certain function or group of functions. In some implementations, computer-executable instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium including instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method comprising:
receiving, in connection with administering a test, a first set of user information from a first client device associated with a first user;
receiving, in connection with administering the test, a second set of user information from a second client device associated with a second user;
generating a first set of personalized test questions based on the first set of user information into a template of parameterized variable test questions;
generating a second set of personalized test questions based on the second set of user information into the template of parameterized variable test questions, wherein the first set of personalized test questions differs from the second set of personalized test questions;
providing the first set of personalized test questions to the first client device; and
providing the second set of personalized test questions to the second client device.

2. The computer-implemented method of claim 1, further comprising:
determine additional contextual information by querying the first set of user information; and
generating the first set of personalized test questions by incorporating the first set of user information and the additional contextual information into the template of parameterized variable test questions.

3. A computer-implemented method comprising:
identifying a first set of user information corresponding to a first user;
identifying a second set of user information corresponding to a second user, wherein the first set of user information differs from the second set of user information;
accessing a template of content items, wherein each of the content items includes one or more parameterized variables;
generating a first set of content items by incorporating the first set of user information into the template of content items;
generating a second set of content items by incorporating the second set of user information into the template of content items, wherein the first set of content items differs from the second set of content items;
providing the first set of content items to a first client device associated with the first user; and
providing the second set of content items to a second client device associated with the second user.

4. The computer-implemented method of claim 3, wherein:
the template of content items corresponds to a set of test questions;
generating the first set of content items comprises generating a first set of test questions rewritten to incorporate personalized information of the first user determined from the first set of user information; and
providing the first set of content items to the first client device comprises providing the first set of test questions personalized for the first user to the first user.

5. The computer-implemented method of claim 3, wherein identifying the first set of user information corresponding to the first user comprises receiving user input from the first user via the first client device.

6. The computer-implemented method of claim 3, wherein identifying the first set of user information corresponding to the first user comprises receiving user input from the first user via a third client device that is different from the first client device.

7. The computer-implemented method of claim 3, wherein identifying the first set of user information corresponding to the first user comprises accessing the first set of user information from a user profile database that stores sets of user information.

8. The computer-implemented method of claim 7, wherein the template of content items is stored in a database that is separate from the user profile database.

9. The computer-implemented method of claim 3, wherein identifying the first set of user information corresponding to the first user comprises:
receiving an initial set of user inputs from the first user; and
performing queries using the initial set of user inputs to determine the first set of user information.

10. The computer-implemented method of claim 9, wherein:
the initial set of user inputs includes a location; and
determining the first set of user information includes identifying names, places, people, and features corresponding to the location.

11. The computer-implemented method of claim 3, wherein identifying the first set of user information corresponding to the first user occurs around a same time and/or in connection with generating and providing the first set of content items to the first client device.

12. The computer-implemented method of claim 3, wherein identifying the first set of user information corresponding to the first user occurs at a previous and separate time from generating and providing the first set of content items to the first client device.

13. The computer-implemented method of claim 12, further comprising:
accessing an additional template of additional content items, wherein each of the additional content items includes one or more parameterized variables;
generating a third set of content items by incorporating the first set of user information into the additional template of additional content items; and
providing the third set of content items to a third client device associated with the first user.

14. The computer-implemented method of claim 3, wherein a parameterized variable for a content item in the template includes a parameter tag identifying a part of speech.

15. The computer-implemented method of claim 3, wherein a parameterized variable for a content item in the template includes a parameter tag identifying an object type.

16. The computer-implemented method of claim 3, wherein a parameterized variable for a content item in the template includes a parameter tag identifying a corresponding object value range.

17. The computer-implemented method of claim 3, wherein a parameterized variable for a content item in the template is associated with a numerical value or fixed element with the content item.

18. The computer-implemented method of claim 3, wherein the template is associated with a computerized test or examination.

19. The computer-implemented method of claim 3, wherein the template is associated with a lesson or a homework assignment.

20. A system comprising:
a processor;
a computer memory that includes:
a first set of user information associated with a first user and a second set of user information associated with a second user, the first set of user information differing from the second set of user information; and
a template of content items, each of the content items including one or more parameterized variables; and
instructions that, when executed by the processor, cause the system to carry out operations that include:
generating a first set of content items by incorporating the first set of user information into the template of content items;
generating a second set of content items by incorporating the second set of user information into the template of content items, wherein the first set of content items differs from the second set of content items;
providing the first set of content items to a first client device associated with the first user; and
providing the second set of content items to a second client device associated with the second user.
